(19) United States
(12) Patent Application Publication
(10) Pub. No.: US 2012/0127520 A1
(43) Pub. Date: May 24, 2012

(54) OPERATION PANEL AND IMAGE FORMING APPARATUS

(75) Inventors: Satoshi SHIMAO, Tokyo (JP); Masashi SUGANO, Tokyo (JP); Akinori KIMATA, Toyokawa-shi (JP); Katsunori TAKAHASHI, Tokyo (JP); Akifumi ISOBE, Hidaka-shi (JP); Kenji TAMAKI, Tokorozawa-shi (JP)

(73) Assignee: KONICA MINOLTA BUSINESS TECHNOLOGIES, INC., Tokyo (JP)

(21) Appl. No.: 13/291,485

(22) Filed: Nov. 8, 2011

(30) Foreign Application Priority Data
Nov. 18, 2010 (JP) 2010-258323

(51) Int. Cl. G06F 3/12

(52) U.S. Cl. 358/1.15

(57) ABSTRACT

Provided is an operation panel using a touch panel method disposed on an image forming apparatus, wherein a CPU judges whether the same coordinate of an input section is in a pressurization when the operation panel is turned on and whether the first time period has elapsed while the above pressurization continues at the same coordinate, makes a display section to display a massage that the input section is unusable and a message to prompt a user to switch the input section to a substitution device, judges whether the pressurization continues after the second time period and the first time period have elapsed and makes the display section to display a warning to indicate that a malfunction occurs at the input section of the operation panel in case the input section is judged to be in the pressurization after the second time period elapsed.

This application is based on Japanese Patent Application No. 2010-258323 filed on Nov. 18, 2010, in Japanese Patent Office, the entire content of which is hereby incorporated by reference.

### TECHNICAL FIELD

The present invention relates to a touch panel type operation panel disposed in an image forming apparatus and an image forming apparatus provided with the operation panel thereof, and in particular, to an operation panel to enable input operation even operation is not possible due to dew condensation on the operation panel.

### BACKGROUND OF THE INVENTION

In recent years, as an input device of the image forming apparatus, there is widely used a touch panel type operation panel which is intuitively comprehensive and easy to operate. The touch panel type operation panel is configured by combining and integrating a display section to display given information and an input section to detect a position at which pressure is applied by a finger of a user or a dedicated pen on the operation panel. A control section of the image forming apparatus conducts each function corresponding items designated by the pressing operation based on positional information supplied from the touch panel.

Here, in the conventional touch panel type operation panel, if the image forming apparatus is started when temperature of a room, where the image forming apparatus is installed, is low, temperature inside the image forming apparatus rises by the operation of the image forming apparatus, a dew may be condensed inside the operation panel. Also, in case temperature and humidity are high in the room, if the apparatus is cooled rapidly by an air conditioning, the dew may be condensed inside the touch panel.

If the dew is condensed inside the touch panel, there is possibility that a position on the touch panel is subject to a continuous conduction state. In the above state, even if the user presses to operate the operation screen, the touch panel does not accept input operation, thus there is a problem that the operation through the touch panel is not possible.

In order to prevent dew condensation in the touch panel, in Patent Document 1, there is suggested a touch panel having a water absorbing layer disposed at a vicinity of an inner circumference of an isolation spacer in a shape of a picture frame which is formed on outer circumference on a lower surface of an upper substrate or an upper surface of a lower substrate. Also, in Patent Document 2, there is suggested a touch panel configured with a glass and a film which are glued each other only at outer circumferences with a gluing material, wherein an electrode configured with a material including a desiccant agent is disposed at an outer circumference of the gluing material. Further, in Patent Document 3, there is suggested a touch panel provided with a moisture penetration prohibition layer which is disposed between a second transparent substrate configured with a polymer film and a second transparent conducting film disposed on a lower surface thereof.
Patent Document 1: Unexamined Japanese Patent Application Publication No. 2009-093398
Patent Document 2: Unexamined Japanese Patent Application Publication No. 2006-215941
Patent Document 3: Unexamined Japanese Patent Application Publication No. 2006-072694

Incidentally, in recent years, the operation panels have become larger for a purpose of enhancing visibility and operability and size of the glass substrate has become larger as the touch panel has become larger. Accordingly, temperature in the glass substrate is becoming difficult to change evenly and as a result there is a problem that the dew is condensed in the operation panel due to a temperature difference in the glass substrate. Thus even if the dew condensation prevention devices disclosed in Patent Documents 1 to 3 are employed, perfection of dew condensation prevention is difficult. Also, the operation panels are often disposed separately from the image forming apparatus main body. Thus in case the above operation panels are used for a long time period in a high humidity atmosphere, there is a problem that the dew can be condensed easily.

As above if operation of the touch panel is impossible due to dew condensation inside the touch panel, generally, resolving of dew in the operation panel is waited or recovering by a service staff is waited. However in the meantime, operation through the operation panel can not be performed completely thus there occur a problem of decreasing productivity.

### SUMMARY

The present invention has one aspect to solve the above problems and an object of the present invention is to provide an image forming apparatus and an operation panel which ensure input operation even if operation of the operation panel is impossible due to dew condensation and so forth.

To achieve the above object the operation panel reflecting one aspect of the present invention, includes an input section employing a touch panel method to detect a pressed position, a notification section to notify an user and a control section to control the notification section so as to prompt the user to use another input section which is a substitute of the input section in case a pressurization of the same position of the input section is continued.

Also, the image forming apparatus reflecting on aspect of the present invention, includes an touch panel type operation panel having an input section to detect a position pressed by the user and a notification section to notify the user and a control section to control the notification section so as to use another input section which is a substitution for the input section in case a pressurization is continued at the same position of the input section.

Further, in the image forming apparatus reflecting on aspect of the present invention, in case the pressurization at the same position is continuously detected through a predetermined time period due to condensation of dew inside the input section or placing a foreign matter on the input section. Use of the input section is disabled until the pressuring of the same position is resolved. Thus, the control section displays a message to prompt the user to switch use of the input section to use of another device which is a substitution device of the input device. As the other input section, for example, a mouse and a keyboard having an equivalent function to the touch panel type input section.

### BRIEF DESCRIPTION OF THE DRAWINGS

FIG. 1 is a diagram showing an exemplary external configuration of an image forming apparatus related to a first embodiment of the present invention.

FIG. 2 is a block diagram showing an image forming apparatus.

FIG. 3 is a flow chart showing an exemplary operation of an image forming apparatus.

FIG. 4 shows an exemplary block configuration of an image forming apparatus related to a second embodiment of the present invention.

FIG. 5 is a flow chart showing an exemplary operation of an image forming apparatus.

### DETAILED DESCRIPTION OF PREFERRED EMBODIMENT(S)

A preferable embodiment (hereinafter called embodiment) of the present invention will be described in the following.

### 1. First Embodiment of the Present Invention

### Exemplary External View of Image Forming Apparatus

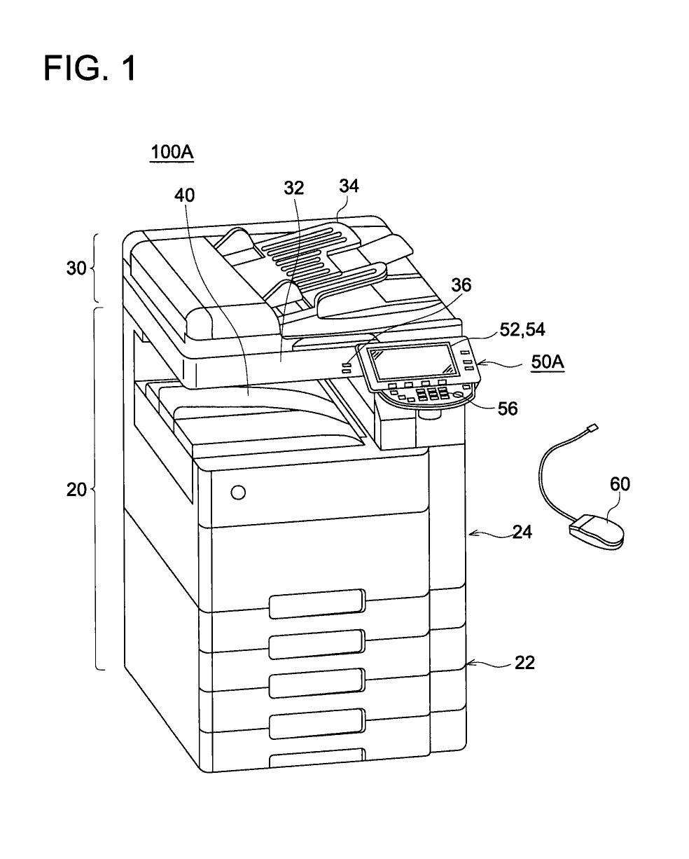

FIG. 1 shows an exemplary configuration of an image forming apparatus 100A related to the first embodiment of the present invention.

The image forming apparatus 100A enables to continue input operation of the image forming apparatus 100A by displaying a massage to prompt the user to switch to the substitution input section 60 wherein a user connects a substitution input section 60 to the image forming apparatus 100 in accordance with a guide displayed on a screen, even in case operation becomes impossible due to condensation of dew in the operation panel 50A.

The image forming apparatus 100A is a multifunction peripheral having functions of a copying machine, a scanner, a printer and a facsimile connected to unillustrated terminal devices via a network. As FIG. 1 shows, the image forming apparatus 100A is provided with an image forming apparatus main body 20, and an image reading section 30 disposed above the image forming apparatus 20.

The image reading section 30 is provided with a scanner unit 32 to read a document image, an automatic document feeder (ADF) unit 34 disposed above the scanner unit 32. The image forming apparatus main body 20 is provided with a sheet feeding section 22 and a printing section 24 disposed above the sheet feeding section 22. The sheet feeding section 22 is configured with, for example, a four stage sheet tray in which sheets of A4, B5 and so on are stored in the trays respectively.

The printing section 24 transfers a toner image onto a sheet fed from the sheet feeding section 22 via a known electrophotographic method based on image data created by the scanner unit 32 or transmitted from the terminal apparatus via the network. The sheet on which the toner image has been transferred via the printing unit 24 is ejected to a sheet ejection tray disposed under the scanner unit 32.

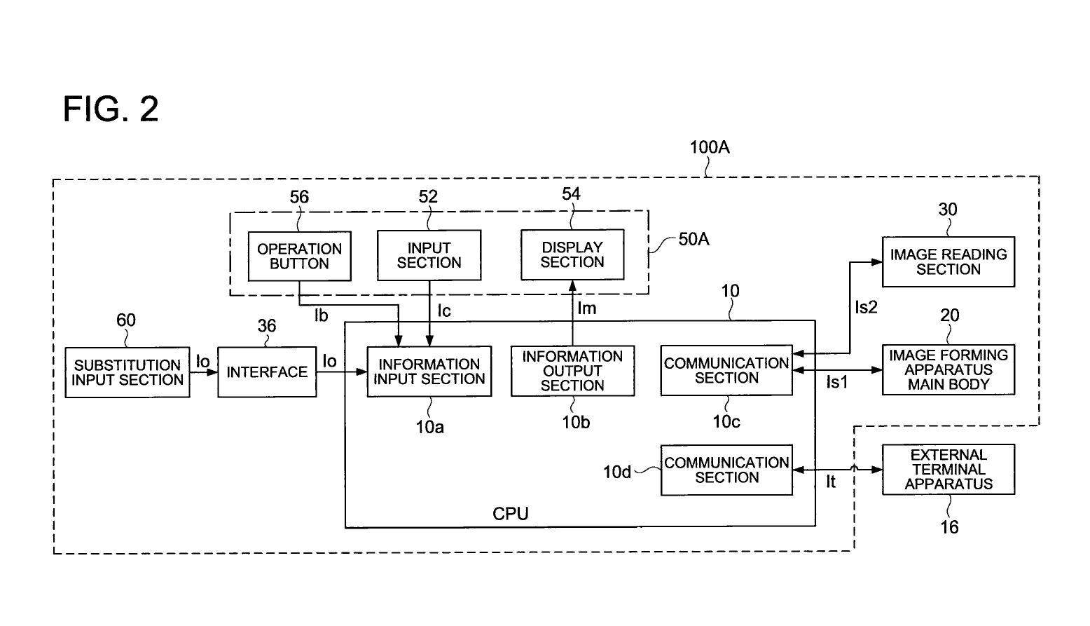

An operation panel 50A is disposed at a front section of the scanner unit 32. The operation panel 50A is provided with a touch panel type input section 52 to input information, a display section 54 to display a menu screen and so forth and a plurality of buttons 56 disposed at a peripheral section of the display section 54 which are different from the touch panel method input section 52. The input section 52 and the display section 54 are combined and integrated (refer to FIG. 2).

In a periphery of the operation panel 50A, there is provided an input interface section 36 which connects the substitution input section 60, having equivalent functions to that of the input section 52, with the image forming apparatus main body 20, in case the operation panel 50A becomes inoperative due to dew condensation or a trouble. As the input interface section 36, for example, standardized communication method such as USB (universal serial bus) is used. Incidentally, the position of the input interface section 36 is not limited to the above position.

As the substitution input section (other input section) 60, for example, a mouse, a keyboard and a wireless or wired type portable terminal (mobile operation section) can be used. In case the mobile terminal is used, a comprehensive operation screen is displayed on the display screen to operate the image forming apparatus 100A. FIG. 1 shows an example using the mouse. In case the mouse is used as the substitution input section 60, for example, a plane member to place the mouse can be mounted at the operation panel 50A or image forming apparatus main body 20 so that the mouse can be used easily. The plane member can be configured to be retractable in the operation panel 50A or the image forming apparatus 20, or to be detachable.

### [Block Configuration of Image Forming Apparatus]

FIG. 2 shows a block configuration of the image forming apparatus 100A. As FIG. 2 shows, the image forming apparatus 100A is provided with a CPU 10, an operation panel 50A, the input interface section 36, the substitution input section 60, the image forming apparatus main body 20 and the image reading section 30.

CPU (Central Processing Unit) 10 is to control an entire operation of the image forming apparatus 100A having an information input section 10a, an information output section 10b, and communication sections 10c and 10d. Incidentally, the CPU 10 configures an exemplary control section.

The information input section 10a being connected with an input section 52 of the operation panel 50A, operation buttons 56 and an input interface 36 acquires coordinate information (positional information) Ic inputted from the operation panel 50A and operation information Io inputted from the substitution input section 60 via or the input interface section 36.

The information output section 10b being connected with the display section 54 of the operation panel 50A creates mechanical information Im such as due condensation and malfunction of the operation panel 50A based on the coordinate information Ic inputted from the input section 52 and outputs to the display section 54.

The communication section 10c being connected with the image forming apparatus main body 20 and the image reading section 30 creates control information Is1, and Is2 based on, for example, the coordinate information Ic inputted from the input section 52 or the substitution input section 60 and based on operation information Io and outputs to the image forming apparatus main body 20 and the image reading section 30 respectively.

The communication section 10d being connected with an external terminal 16 via a network transmits trouble information It to the external terminal device 16 in case a trouble occurs in the operation panel 50A. The external terminal device 16 can be a server to administrate the image forming apparatus 100A to be connected with the network or a control terminal device of an external service center.

The operation panel 50A is provided with an input section 52, a display section 54 and operation buttons 56. The input section 52 detects a position pressed with a finger or a pen by a user on the operation screen and the coordinate information Ic thereof is supplied to the information input section 10a of the CPU 10. The input section 52 is configured not to accept operation of the other coordinate when a coordinate position is conductive by pressing. The input section 52 employs a resistance film method to detect change of voltage or electrostatic capacity method to detect change of electrostatic capacity.

The display section 54 being configured with, for example, a liquid crystal panel or an organic electroluminescence panel, displays a predetermined image based on the coordinate information Ic detected by the input section 52. For example, the display section 54 displays a cause of continuous pressurization in case the pressurization is continued at the same coordinate of the input section 52 and a counter measure thereof on the operation screen. Also, the display section 54 displays a message to indicate a malfunction of the input section 52 and to prompt the user to contact with a service staff on the operation screen.

The operation buttons 56 configured with a plurality of numerical keys, a starting button and an entry button create operation signal Ib in accordance with button operation by the user and supply to the information input section 10a.

The image forming apparatus main body 20, provided with a sheet feeding section 22 and a printing section 24 (refer to FIG. 1), feed sheet to printing section 24 and transfer a toner image onto the sheet based of control information Is1 supplied from the communication section 10c of the CPU 10. The reading section 30, provided with the scanner unit 32 and the automatic document feeding unit 34 (refer to FIG. 1), reads the document to create an image data based on the control information Is2 supplied from the communication section 10c of the CPU 10 and supplies the image data to the printing section 24.

An input interface section 36 represents a connection section to connect the substitution input section 60 with the information input section 10 of the CPU 10. The substitution input section 60 disposed at the input interface section 36 in a detachable manner is used as a substitution input device for the unusable input section 52. In case the substitution device 60 is a mouse, the mouse moves a cursor indicated on the operation screen of the display section 54 so that a given item on the operation screen is selected, whereby the operation information Io is supplied to the information input section 10a of the CPU 10 via the input interface section 36. Also, in case the substitution input section 60 is a keyboard, by selecting keys of the keyboard, the operation information Io is supplied to the information input section 10a of the CPU 10 via the input interface section 36.

### [Exemplary Operation of Image Forming Apparatus]

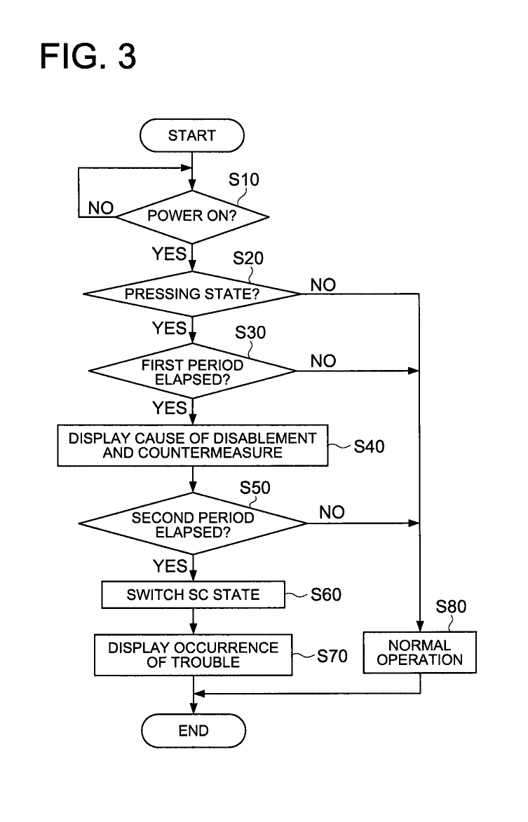

FIG. 3 shows an exemplary operation of the image forming apparatus 100A related to a first embodiment of the present invention. As FIG. 3 shows, in Step S10, the CPU 10 judges whether or not the power of the operation panel 50A is turned on. If the power of the operation panel is judged to be tuned on, the CPU 10 proceeds with Step S20, and if it is judged to be not tuned on, it will waited until the power is turned on.

In Step S20, the CPU 10 judges whether or not a given coordinate on the operation screen of the input section 52 of the operation panel 50A is in pressurization. For example, a case that the same coordinate is in pressurization by condensing due, and a case that the same coordinate is in pressurization due to damage or trouble are subject to judgment. When the CPU 10 judges that the same coordinate on the input section 52 is in pressurization, the CPU proceeds with Step S30. On the other hand, when the CPU 10 judges that the same coordinate on the input section 52 is not in pressurization, the CPU proceeds with Step S80 to conduct a normal operation.

In Step S30 the CPU 10 judges whether or not the pressurization of the same coordinate on the operation screen of the input section 52 continues through first time period. Here, the first time period is a time period to display the cause and the countermeasure on the display section 54 to notify the user, in case the operation panel 50 A become unusable due to some reasons (for example, condensing dew, foreign matter or trouble), and is set to be several minutes. Information of the first time period can be stored in an unillustrated memory such as a ROM. In case the CPU 10 judges that the first time period has elapsed while pressurization of the same coordinate continues, the CPU 10 proceeds with Step S40 since CPU recognizes some causes continue pressurization, for example, a case that the same coordinate continues to keep a conductive state due to condensing dew inside the input section 52 or a case that the same coordinate continues to keep a conductive state due to a trouble such a damage of the input section 52. On the other hand in case release of pressurization before elapsing the first time period is judged, Step S80 proceeds, for example, a case that a user presses a given coordinate on the operation screen for input ordinary information input and information input is completed within the first time period thus it became non-pressurization.

In Step S40, the CPU 10 displays a message that input section 52 is unusable, a message (countermeasure) to prompt changing to substitution device from the input section 52 on the screen of the display section 54. Specifically, a message of “Touch operation of the operation panel is usable at this stage. Please connect the mouse. Scanning and printing can be carried out normally” is displayed. An animation can be used to show connection method of the mouse.

In Step S50, the CPU 10 judges whether or not the pressurization continues in a second time period in case the same coordinate is in pressurization after elapsing the first time period. Here, the second time period is set so as to judge whether the pressurization is caused by dew condensation or by a trouble, which is a time period where the dew condensation occurred in the input section 52 is usually resolved i.e. several hours. Incidentally, the second time period is preferable to be set with taking account of the first time period. Thus, in case the dew is condensed in the operation panel 50A, dew condensation (pressurization) is resolved after elapsing the second time period. Information of the second time period can be stored in a memory such as an unillustrated ROM. The CPU 10 proceeds with Step S60 supposing that a trouble occurred in the input section 52 in case the second time period is judged to have elapsed while continuing pressurization of the same coordinate. On the other hand, in case pressurization of the same coordinate is judged to be released before elapsing of the second time period, the dew of the input section 52 is judged to be resolved and Step S80 proceeds. Here, in case the input section 52 becomes usable normally by resolving the dew, input operation by both the input section 52 and the substitution input section 60 is possible.

In Step S60, the CPU 10 switches system function to a service call state since the input section 52 of the operation panel 50A malfunctions. After switching to the service call state, Step S70 will proceed.

In Step S70, the CPU 10 displays a warming that malfunction occurs at the input section 52 of the operation panel 50A on the display section 54. For example, a warning message of “A malfunction has occurred on the operation panel. Please contact with the service staff” is displayed on the screen of the display section 54.

As described in the foregoing, according to the first embodiment, even in case the operation of the input section 52 of the operation panel 50 A is unusable temporally or continuously due to dew condensing, foreign matters or malfunctions, by displaying the message to switch from use of the input section 52 which is unusable to use of the substitution input section 60 on the operation screen of the display section 54 and by connecting the substitution section 60 with the input interface section 36 of the image forming apparatus 100A in accordance with the message displayed, input operation can be restarted.

### 2. Second Embodiment

The second embodiment is different from the above first embodiment in a point that a moisture sensor section 58 is used to specify a cause in case the pressurizing is caused by dew condensation. Incidentally, since configurations and functions of the image forming apparatus 100B other than the moisture sensor section 58 are the same as that of the image forming apparatus 100A representing the first embodiment, common components are denoted by the same symbols and specific descriptions thereof are omitted.

### [Exemplary Block Configuration of Image Forming Apparatus]

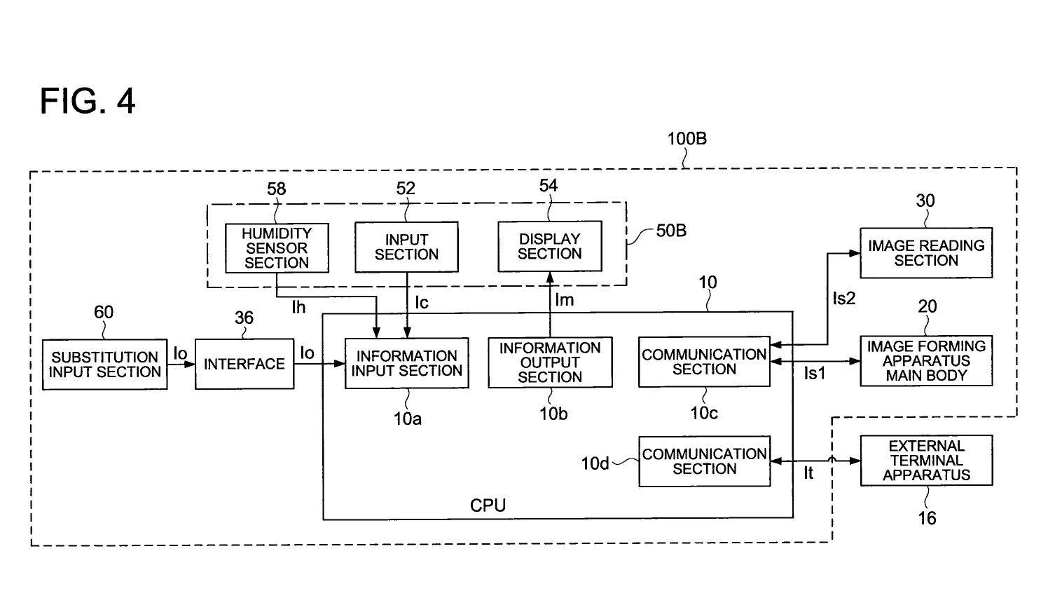

FIG. 4 shows an exemplary block configuration of an image forming apparatus 100B related to a second embodiment of the present invention. As FIG. 4 shows, the image forming apparatus 100B is provided with a CPU 10, an operation panel 50B, an input interface section 36, a substitution input section 60, an image forming apparatus main body 20 and an image reading section 30.

The operation panel 50B is provided with an input section 52, a display section 54 and a moisture sensor section 58. The moisture sensor section 58 installed inside the input section 52 is connected with the information input section 10a of the CPU 10 so as to supply measurement information Ih to the information input section 10a by measuring moisture inside the input section 52. As the moisture sensor section 58, for example, a wet-and-dry-bulb hygrometer, a hair hygrometer, a crystal vibration hygrometer, a polymer resistance, a polymer capacitance hygrometer or an oxidized aluminum hygrometer is used.

### [Exemplary Operation of Image Forming Apparatus]

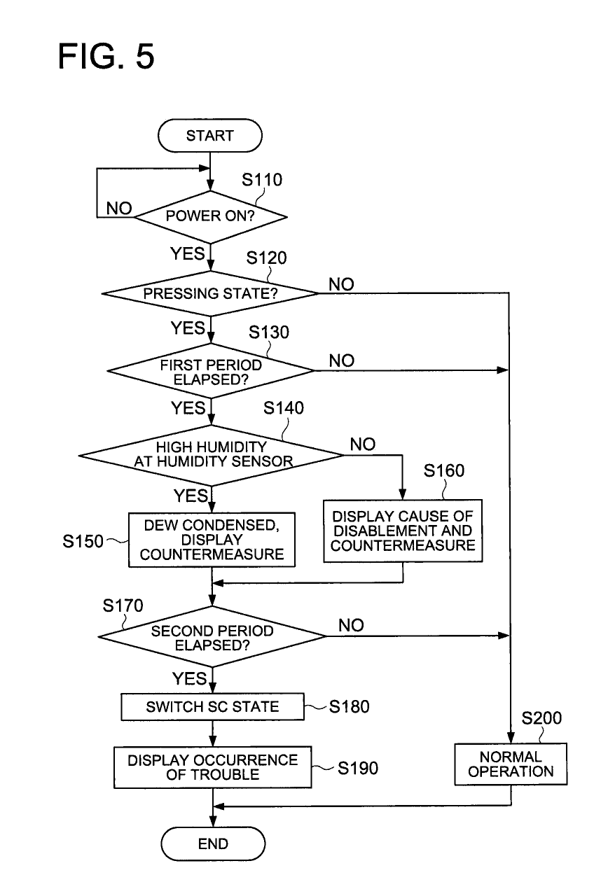

FIG. 5 shows an exemplary operation of the image forming apparatus 100B related to the second embodiment of the present invention. Since operations in Steps S110 to S130 shown by FIG. 5 are the same as that in Steps S10 to S30 of the first embodiment, descriptions are omitted.

In case the first time period is judged to have elapsed in Step S130, the CPU 10 judges whether or not dew is condensed inside the input section 52 based on the measurement information Ih supplied from the moisture sensor section 58. The CPU judges that the dew is condensed in the input section 52 in case that humidity inside the input section 52 is a high humidity (for example 90%) and proceeds with Step S150, and if the CPU judges that the dew is not condensed, it proceeds with Step S160.

In case dew condensation is detected by the moisture sensor section 58, the CPU 10 displays a message that the input section 52 is unusable, a message that the cause of disablement is dew condensation and a message to prompt switching to the substitution input section 60 on the operation screen of the display section 54. Whereby, the user understands that the cause of disablement of the input section 52 is dew condensation inside the input section 52.

On the other hand, in case it is judged that dew condensation does not occur inside the input section 52, the CPU 10 displays a message that input section 52 is usable, and a message to prompt switching to the substitution input section from the input section 52 (countermeasure) on the screen of the display section 54. Whereby, the user understands that the cause of disablement of the input section 52 is other cause than dew condensation.

The operations from Steps S170 to S200 are the same as that in Steps S50 to S80, descriptions are omitted.

As described in the foregoing, according to the second embodiment, the same effect as that of the first embodiment can be achieved and by disposing the moisture sensor section 58 in the input section 52, the cause of trouble is displayed in case the dew condensation causes disablement of the operation panel 50B, thus the user can understand the cause of the disablement of the operation panel 50B accurately.

Incidentally the scope of the present invention is not limited to the above embodiments and variations of the above embodiments are included without departing spirit or scope of the present invention. In the above first and second embodiments, the CPU 10 is disposed in a place separated from the operation panels 50A and 50B, however the CPU 10 can be disposed inside the operation panels 50A and 50B without being limited to the above configuration. Also, a calculation processing section (control section) can be installed inside the operation panels 50A and 50B to execute the above operations. In this case, burden of the CPU 10 of the image forming apparatuses 100A and 100B can be reduced.

In the above embodiments, the message that input section 52 is unusable or the message (countermeasure) to prompt the user to switch the input section 52 to the substitution device which is the substitute for the input section 52 are displayed on the display section 54. Other than the above method, for example, an audio notification to the used is possible and combination of the display and the audio notification is also possible. Further, as the image forming method, the electrophotographic method was exemplified in the forgoing however, other methods such as an inkjet method and thermal method can be used as we all know.

According to the embodiments reflecting the aspect of the present invention, even in case the operation becomes impossible temporally or continuously due to condensation of dew inside the touch panel type operation panel, leaving a foreign matter or a trouble, since the notification section notifies to switch the unusable input section to the substitution input section, input can be restarted using the substitution input section.

What is claimed is:

1. An operation panel, comprising:
an input section employing a touch panel method to detect a pressed position;
a notification section to notify an user, and
a control section to control the notification section so as to prompt the user to use another input section to be a substitute for the input section in case a pressurization of a same position of the input section is continued.

2. The operation panel of claim 1, wherein the control section controls the notification section to notify that the input section is unusable in case the pressurization of the same position of the input section is detected continuously through a first time period set in advance.

3. The operation panel of claim 1, wherein the control section controls the notification section to notify occurrence of a malfunction in case the pressurization of the same position of the input section is detected continuously through a second time period set in advance after the first time period has elapsed.

4. The operation panel of claim 1, wherein the control section controls the notification section to notify that a mouse or a keyboard can be used as another input section.

5. The operation panel of claim 1, having a moisture sensor section disposed inside the input section to detect moisture inside the input section thereof, wherein the control section controls the notification section to notify that dew is condensed inside the input section in case the control section judges that dew condensation occurs based on a measuring result measured by the moisture sensor.

6. The operation panel of claim 1, wherein the notification section is a display section to display based on the position detected by the input section.

7. An image forming apparatus, comprising:
an operation panel employing a touch panel method having an input section to detect a pressed position and a notification section to notify a user; and
a control section to control the notification section so as to prompt the user to use another input section to be a substitute for the input section in case a pressurization of the same position of the input section is continued.

8. The image forming apparatus of claim 7, wherein the control section controls the notification section to notify that the input section is unusable in case the pressurization of the same position of the input section is detected continuously through a first time period set in advance.

9. The image forming apparatus of claim 7, wherein the control section controls the notification section to notify occurrence of a malfunction in case the pressurization of the same position of the input section is detected continuously through a second time period set in advance after the first time period has elapsed.

10. The image forming apparatus of claim 7, wherein the control section controls the notification section to notify that a mouse or a keyboard can be used as another input section.

11. The image forming apparatus of claim 7, having a moisture sensor section disposed inside the input section to detect moisture inside the input section thereof wherein the control section controls the notification section to notify that dew is condensed inside the input section in case the control section judges that dew condensation occurs based on a measuring result measured by the moisture sensor.

12. The image forming apparatus of claim 7, wherein the notification section is a display section to display based on the position detected by the input section.
